(19) United States
(12) Patent Application Publication
(10) Pub. No.: US 2025/0147543 A1
(43) Pub. Date: May 8, 2025

(54) INTERFACE DEVICE AND OPERATING METHOD THEREOF

(71) Applicant: SK hynix Inc., Icheon-si (KR)

(72) Inventors: Yo Han HONG, Icheon-si (KR); Dae Sik PARK, Icheon-si (KR)

(21) Appl. No.: 18/633,397

(22) Filed: Apr. 11, 2024

(30) Foreign Application Priority Data
Nov. 8, 2023 (KR) 10-2023-0153478

(51) Int. Cl. G06F 1/08

(52) U.S. Cl. CPC G06F 1/08

(57) ABSTRACT

The present disclosure relates to a semiconductor device. A device in communication with a host device via an interface according to the present disclosure includes a clock signal generator configured to generate a first reference clock signal to be used by the device, and a reference clock signal selection circuit coupled to be in communication with the clock signal generator to receive the first reference clock signal and configured to receive a second reference clock signal from the host device, and configured to, in response to a first reset signal received first among a plurality of reset signals from the host device, select one of the first reference clock signal and the second reference clock signal according to whether the second reference clock signal is provided from the host device.

### CROSS-REFERENCE TO RELATED APPLICATION

This patent document claims the priority and benefits of Korean patent application number 10-2023-0153478, filed on Nov. 8, 2023, which is incorporated herein by reference in its entirety.

### TECHNICAL FIELD

The disclosed technology generally relates to a semiconductor device, and more particularly, to an interface device and a method of operating the interface device.

### BACKGROUND

The Peripheral Component Interconnect (PCI) bus standard may define a bus protocol that can be used to connect a host device (e.g., one or more CPUs) to one or more peripheral devices such as a data storage device to carry out various operations including those initiated and/or controlled by the host device. The PCI Express (PCIe) bus standard may be defined by PCI standards and may include a physical communication layer defined as a high-speed serial interface for the host device and peripheral devices.

### SUMMARY

The disclosed technology can be implemented in some embodiments to provide an interface device such as a PCIe device that can automatically select a clock mode between a common clock mode and a separate clock mode when a plurality of reset signals are enabled, and a method of operating the interface device such as the PCIe device.

In addition, various embodiments also provide a PCIe device capable of automatically determining whether to apply spread spectrum clocking, and a method of operating the PCIe device.

In an embodiment, an interface device (e.g., PCIe device) in communication with a host device via an interface may include a clock signal generator configured to generate a first reference clock signal to be used by the interface device, and a reference clock signal selection circuit coupled to be in communication with the clock signal generator to receive the first reference clock signal and configured to receive a second reference clock signal from the host device, and configured to, in response to a first reset signal received first among a plurality of reset signals from the host device, select one of the first reference clock signal and the second reference clock signal according to whether the second reference clock signal is provided from the host device.

In an embodiment, a interface device in communication with a host device may include a receiver configured to receive a data set and a skip ordered set (SKP OS) from the host device based on a first reference clock signal, an elastic buffer coupled to the receiver and configured to store the data set and the skip ordered set, a buffer state detector coupled to the elastic buffer and configured to detect a state of the elastic buffer, and a spread spectrum clocking selection circuit coupled to the receiver and configured to determine whether to activate spread spectrum clocking (SSC) based on a receiving interval at which the skip ordered set is received and a state of the elastic buffer.

In an embodiment, a method of operating a interface device in communication with a host device may include generating a first reference clock signal, selecting one of a common clock mode and a separate clock mode based on a result of comparison between the first reference clock signal generated by the interface device and a second clock signal received from the host device, receiving a data set and a skip ordered set (SKP OS) from the host device based on the first reference clock signal according to the separate clock mode, storing the data set and the skip ordered set in an elastic buffer, and determining whether to apply spread spectrum clocking (SSC) to the first reference clock signal based on a receiving interval at which the skip ordered set is received and a state of the elastic buffer.

In an embodiment, a PCIe controller may include a reference clock signal selection circuit configured to detect a first clock mode, a spread spectrum clocking (SSC) selection circuit configured to output a clock mode selection signal by detecting a second clock mode based on the first clock mode, and a physical layer configured to determine a final clock mode based on the clock mode selection signal.

The first clock mode may include a common clock mode and a separate clock mode, and wherein the second clock mode includes a separate reference clock with independent SSC (SRIS) mode and a separate reference clock with no SSC (SRNS) mode.

The reference clock signal selection circuit may determine the first clock mode by detecting whether a reference clock signal is provided from a host device.

The physical layer further comprises a reference clock signal detector configured to detect the reference clock signal, and wherein the reference clock signal selection circuit is configured to: receive, from the reference clock signal detector, a signal that indicates whether the reference clock signal is detected; and output, based on the received signal, a signal that indicates whether the reference clock signal is provided.

The reference clock signal selection circuit may ignore input of a reset signal provided from a host device when receiving, from the reference clock signal detector, the signal that indicates whether the reference clock signal is detected.

The reference clock signal selection circuit may ignore input of a reset signal provided from a host device until a setting operation of register values associated with detection of the first clock mode is completed.

The physical layer further comprises: a serializer configured to convert and output parallel data into serial data, a deserializer configured to convert and output serial data into parallel data and an elastic buffer configured to store a data set and a skip ordered set.

The spread spectrum clocking selection circuit may output a signal by measuring an interval of the skip ordered set in the elastic buffer in a case that the first clock mode is the separate clock mode.

In a case that the first clock mode is the separate clock mode, the spread spectrum clocking selection circuit may set a first reference value and a second reference value greater than the first reference value, and output a signal that indicates whether the interval of the skip ordered set is less than the first reference value, or a signal that indicates whether the interval of the skip ordered set is greater than the second reference value.

The spread spectrum clocking selection circuit may measure an interval of the skip ordered set by detecting the data set and the skip ordered set based on data received from a host device.

The spread spectrum clocking selection circuit may output, to the physical layer, the clock mode selection signal for activating the SRIS mode.

### BRIEF DESCRIPTION OF THE DRAWINGS

FIG. 1 is a diagram illustrating an example of a peripheral component interconnect express (PCIe) device based on an embodiment of the disclosed technology.

FIG. 2 is a diagram illustrating operations of a reference clock signal selection circuit based on an embodiment of the disclosed technology.

FIG. 3A is a diagram illustrating an example in which a common clock mode is selected based on an embodiment of the disclosed technology.

FIG. 3B is a diagram illustrating an example in which a separate clock mode is selected based on an embodiment of the disclosed technology.

FIG. 4 is a block diagram illustrating a spread spectrum clocking selection circuit based on an embodiment of the disclosed technology.

FIG. 5A is a block diagram illustrating an example in which spread spectrum clocking is activated based on an embodiment of the disclosed technology.

FIG. 5B is a diagram illustrating an example in which spread spectrum clocking is deactivated based on an embodiment of the disclosed technology.

FIG. 6 is a flowchart illustrating a method of operating a PCIe device based on an embodiment of the disclosed technology.

FIG. 7 is a flowchart illustrating an example method of operating a PCIe device determining whether to activate spread spectrum clocking based on an embodiment of the disclosed technology.

FIG. 8 is a flowchart illustrating another example method of operating a PCIe device determining whether to activate spread spectrum clocking based on an embodiment of the disclosed technology.

FIG. 9 is a flowchart illustrating an example of activating application of spread spectrum clocking according to a link state based on an embodiment of the disclosed technology.

FIG. 10 is a flowchart illustrating another example of activating application of spread spectrum clocking according to a link state based on an embodiment of the disclosed technology.

FIG. 11 is a diagram illustrating an example in which spread spectrum clocking is based on an embodiment of the disclosed technology.

FIG. 12 is a diagram illustrating a PCIe system based on an embodiment of the disclosed technology.

### DETAILED DESCRIPTION

Specific structural features or functions for certain embodiments disclosed in this patent document are examples to describe certain implementations of the disclosed technology.

A peripheral component interconnect express (PCIe) device may be connected to a host device with one or more CPUS via a PCIe bus to perform various operations commended by or controlled by the host device based on a reference clock signal. In some implementations, a reference clock signal may be set according to a common clock mode or a separate clock mode.

In the common clock mode, a PCIe device and a host that controls the PCIe device may operate using a common reference clock signal. The common reference clock signal may be generated by a reference clock signal generator included in the host. In the separate clock mode, the PCIe device and the host operate using different reference clock signals. The PCIe device and the host may respectively include reference clock signal generators for generating different reference clock signals.

In addition, the PCIe device may convert a reference clock signal into a clock signal having a spread spectrum by using spread spectrum clocking (SSC).

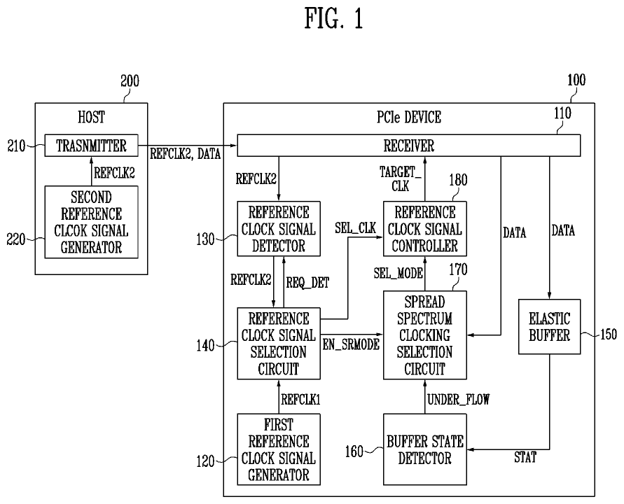

FIG. 1 is a diagram illustrating an example of a PCIe device 100 based on an embodiment of the disclosed technology.

Referring to FIG. 1, the PCIe device 100 and a host 200 may support communication using a PCIe interface.

The PCIe device 100 may include a receiver 110, a first reference clock signal generator 120, a reference clock signal detector 130, a reference clock signal selection circuit 140, an elastic buffer 150, a buffer state detector 160, a spread spectrum clocking selection circuit 170, and a reference clock signal controller 180.

The receiver 110 may receive data DATA from the host 200 through the PCIe interface. The data DATA may include a data set and a skip ordered set. The skip ordered set may be used to perform clock tolerance compensation. More specifically, when there is a frequency difference between a transmitting side and a receiving side, data may be lost due to a difference in data processing speed between the transmitting side and the receiving side. To avoid such data loss, the skip ordered set may be used to compensate for the corresponding frequency difference. The transmitting side may be the host 200 and the receiving side may be the PCIe device 100. The frequency may refer to a frequency of a reference clock signal.

In an embodiment, the receiver 110 may include deserializer, a descrambler, a clock data recovery (CDR) circuit, and the like. The receiver 110 may receive serial data DATA and output parallel data.

The first reference clock signal generator 120 may generate a first reference clock signal REFCLK1. The first reference clock signal REFCLK1 may be generated inside the PCIe device 100.

The reference clock signal detector 130 may detect a second reference clock signal REFCLK2. The second reference clock signal REFCLK2 may be generated by the host 200 outside the PCIe device 100. The first reference clock signal REFCLK1 and the second reference clock signal REFCLK2 may be different from each other.

In an embodiment, the reference clock signal detector 130 may detect the second reference clock signal REFCLK2 in response to a reference clock signal detection request REQ_DET of the reference clock signal selection circuit 140.

The reference clock signal selection circuit 140 may select any one of the first reference clock signal REFCLK1 and the second reference clock signal REFCLK2, depending on whether the second reference clock signal REFCLK2 is provided from the host 200.

In an embodiment, the reference clock signal selection circuit 140 may detect a first clock mode. The first clock mode may include a common clock mode and a separate clock mode.

In an embodiment, the reference clock signal selection circuit 140 may determine whether the second reference clock signal REFCLK2 is provided from the host 200 or not on the basis of a result of comparing the first reference clock signal REFCLK1 with the second reference clock signal REFCLK2.

In an embodiment, when the reference clock signal selection circuit 140 determines that the second reference clock signal REFCLK2 is provided from the host 200, the reference clock signal selection circuit 140 may select the second reference clock signal REFCLK2. The PCIe device 100 and the host 200 may operate in the common clock mode. For example, the PCIe device 100 and the host 200 may operate by commonly using the second reference clock signal REFCLK2.

In an embodiment, when the reference clock signal selection circuit 140 determines that the second reference clock signal REFCLK2 is not provided from the host 200, the reference clock signal selection circuit 140 may select the first reference clock signal REFCLK1. For example, when the reference clock signal selection circuit 140 determines that the host 200 has not sent the second reference clock signal REFCLK2 to the PCIe device 100 during a predetermined time period, the reference clock signal selection circuit 140 may select the first reference clock signal REFCLK1. In this case, the PCIe device 100 and the host 200 may operate in the separate clock mode. For example, the PCIe device 100 may operate using the first reference clock signal REFCLK1, and the host 200 may operate using the second reference clock signal REFCLK2. In addition, the reference clock signal selection circuit 140 may provide a separate clock mode enable signal EN_SRMODE to the spread spectrum clocking selection circuit 170.

In an embodiment, the reference clock signal selection circuit 140 may provide a selected reference clock signal SEL_CLK to the reference clock signal controller 180.

The elastic buffer 150 may store the data set and the skip ordered set received through the receiver 110.

In an embodiment, the elastic buffer 150 may perform clock tolerance compensation using the skip ordered set.

The buffer state detector 160 may detect a state STAT of the elastic buffer 150.

In an embodiment, the state STAT of the elastic buffer 150 may include a normal state, an overflow state, and an underflow state UNDER_FLOW. The overflow state or the underflow state UNDER_FLOW may occur when the transmitting side and the receiving side operate at different frequencies. For example, in memory buffers such as the elastic buffer 150, overflow occurs even in a case where an input frequency of the data symbol is greater than an output frequency, and underflow occurs even in a case where the output frequency of the data symbol is greater than the input frequency.

The spread spectrum clocking selection circuit 170 may determine whether to activate spread spectrum clocking in response to the separate clock mode enable signal EN_SRMODE.

In an embodiment, when the first clock mode is a separate clock mode, the spread spectrum clocking selection circuit 170 may detect a second clock mode to output a clock mode selection signal. The second clock mode may include a first mode in which spread spectrum clocking is activated and a second mode in which spread spectrum clocking is deactivated. The first mode may be a “separate reference clock with independent SSC (SRIS)” mode. The second mode may be a “separate reference clock with no SSC (SRNS)” mode.

In an embodiment, the spread spectrum clocking selection circuit 170 may determine whether to activate spread spectrum clocking on the basis of an interval at which the skip ordered set is received, and the state STAT of the elastic buffer 150. The receiving interval of the skip ordered set may be set based on an absolute value of the frequency difference between the transmitting side and the receiving side.

In an embodiment, the spread spectrum clocking selection circuit 170 may select any one of the first mode and the second mode. The first mode may be the SRIS mode. The second mode may be the SRNS mode. The spread spectrum clocking selection circuit 170 may send a selected mode SEL_MODE to the reference clock signal controller 180.

The reference clock signal controller 180 may generate a target reference clock signal TARGET_CLK having a spread spectrum from the first reference clock signal REFCLK1 when the spread spectrum clocking is activated.

For example, when the selected mode SEL_MODE is the first mode, the reference clock signal controller 180 may generate the target reference clock signal TARGET_CLK by applying spread spectrum clocking to the first reference clock signal REFCLK1. The PCIe device 100 may operate using the target reference clock signal TARGET_CLK.

The host 200 may include a transmitter 210 and a second reference clock signal generator 220.

The transmitter 210 may provide the data DATA to the PCIe device 100 through the PCIe interface.

In an embodiment, when the transmitter 210 provides data sets to the PCIe device 100, skip ordered sets may be interposed between the data sets at predetermined intervals.

In an embodiment, the transmitter 210 may include a serializer, a scrambler, and the like. In an embodiment, the transmitter 210 may convert parallel data into the serial data DATA and output the serial data DATA.

The second reference clock signal generator 220 may generate the second reference clock signal REFCLK2. In a common clock mode, the transmitter 210 may provide the second reference clock signal REFCLK2 to the PCIe device 100.

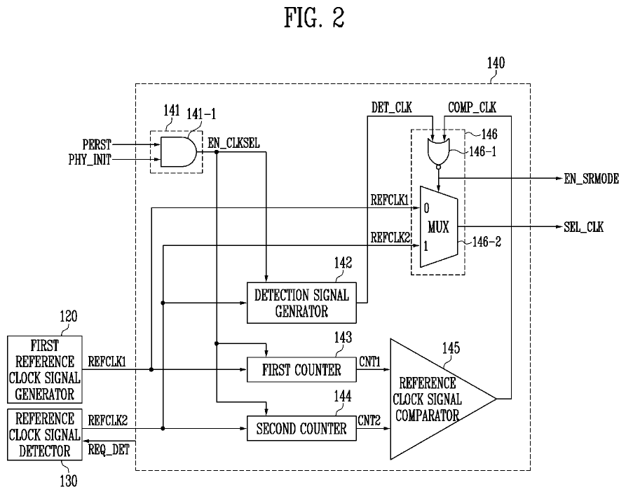

FIG. 2 is a diagram illustrating operations of the reference clock signal selection circuit 140 based on an embodiment of the disclosed technology.

Referring to FIG. 2, the reference clock signal selection circuit 140 may include a selection circuit controller 141, a detection signal generator 142, a first counter 143, a second counter 144, a reference clock signal comparator 145, and a reference clock signal selector 146.

The selection circuit controller 141 may control the reference clock signal selection circuit 140 to perform an operation of selecting a reference clock signal. In an embodiment, the selection circuit controller 141 may include an AND gate circuit 141-1.

In an embodiment, the selection circuit controller 141 may control the reference clock signal selection circuit 140 to perform an operation of selecting a reference clock signal in response to a reset signal PERST that is received first among a plurality of reset signals received from the host 200.

A reset signal may be provided to perform a reset operation within the PCIe device 100, e.g., to initialize register values which are set to the PCIe device 100 and reset the register values. In an embodiment, the first-received reset signal PERST may be a reset signal PERST that is received from the host 200 first after a previous reference clock signal selected before the current reference clock signal is selected by the reference clock signal selection circuit 140.

In an embodiment, the selection circuit controller 141 may generate a control signal EN_CLKSEL for instructing to perform an operation of selecting a reference clock signal when the first received reset signal PERST and a physical layer initialization signal PHY_INIT are enabled.

In an embodiment, the physical layer initialization signal PHY_INIT may be enabled until the operation of selecting the reference clock signal and an operation of setting initial register values of a physical layer are completed.

In an embodiment, the selection circuit controller 141 may ignore the input of the reset signal provided from the host 200 when receiving a signal indicating whether the reference clock signal is detected or not from the reference clock signal detector 130.

In an embodiment, the selection circuit controller 141 may ignore the input of the reset signal provided from the host 200 until the operation of setting the register values associated with the operation of selecting the reference clock signal is completed.

In an embodiment, when the selection circuit controller 141 receives another reset signal other than the first received reset signal PERST among the plurality of reset signals, the selection circuit controller 141 may block an operation caused by the reset signal until the operation of selecting the reference clock signal and the operation of setting the initial register values of the physical layer are completed.

For example, when the selection circuit controller 141 receives another reset signal during the operation of selecting the reference clock signal and the operation of setting the initial register values of the physical layer, the selection circuit controller 141 may block an operation triggered by the reset signal.

In an embodiment, the reference clock signal selection circuit 140 may provide the reference clock signal detection request REQ_DET to the reference clock signal detector 130 in response to the control signal EN_CLKSEL. The reference clock signal detector 130 may generate a signal indicating that the detected signal is valid, together with a signal indicating whether the second reference clock signal REFCLK2 is detected. The reference clock signal detector 130 may provide the detection signal generator 142 with the signal indicating whether the second reference clock signal REFCLK2 is detected.

The detection signal generator 142 may generate a detection signal DET_CLK depending on whether the second reference clock signal REFCLK2 is detected. For example, when the second reference clock signal REFCLK2 is detected by the reference clock signal detector 130, the detection signal generator 142 may enable the detection signal DET_CLK. On the other hand, when the second reference clock signal REFCLK2 is not detected by the reference clock signal detector 130, the detection signal generator 142 may disable the detection signal DET_CLK. The detection signal generator 142 may provide the detection signal DET_CLK to the reference clock signal selector 146.

The first counter 143 may count the number of times the first reference clock signal REFCLK1 is toggled (e.g., number of toggles between the binary representations of 0 and 1) and output a first count value CNT1 in response to the control signal EN_CLKSEL.

The second counter 144 may count the number of times the second reference clock signal REFCLK2 is toggled and output a second count value CNT2 in response to the control signal EN_CLKSEL.

The reference clock signal comparator 145 may compare the first count value CNT1 with the second count value CNT2. The reference clock signal comparator 145 may provide the reference clock signal selector 146 with a comparison result COMP_CLK of comparing the first count value CNT1 with the second count value CNT2.

The reference clock signal selector 146 may select any one reference clock signal on the basis of the detection signal DET_CLK and the comparison result COMP_CLK.

In an embodiment, the reference clock signal selector 146 may include a NOR gate circuit 146-1 and a multiplexer (MUX) 146-2.

In an embodiment, the NOR gate circuit 146-1 of the reference clock signal selector 146 may receive the detection signal DET_CLK and the comparison result COMP_CLK. The NOR gate circuit 146-1 may output a common clock mode enable signal or the separate clock mode enable signal EN_SRMODE to the multiplexer 146-2 in response to the detection signal DET_CLK and the comparison result COMP_CLK.

In an embodiment, when the multiplexer 146-2 receives the common clock mode enable signal, the multiplexer 146-2 may output the second reference clock signal REFCLK2 as a selected reference clock signal SEL_CLK. On the other hand, when the multiplexer 146-2 receives the separate clock mode enable signal EN_SRMODE, the multiplexer 146-2 may output the first reference clock signal REFCLK1 as the selected reference clock signal SEL_CLKK.

When assertions and de-assertions associated with a glitch are repeated at a time when the reset signal PERST is released, it may be determined that an operation of selecting a common clock mode or a separate clock mode is stably performed by the PCIe device 100.

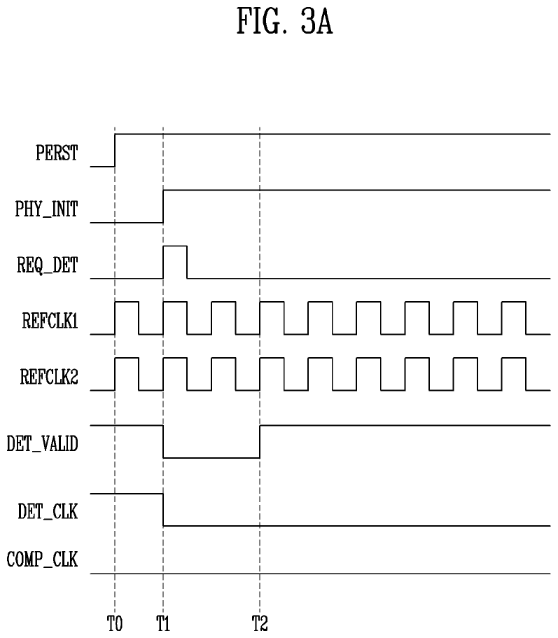

FIG. 3A is a diagram illustrating an example in which a common clock mode is selected based on an embodiment of the disclosed technology.

Referring to FIGS. 2 and 3A, the reset signal PERST may be enabled at TO.

At T1, the physical layer initialization signal PHY_INIT may be enabled in response to the reset signal PERST.

When the reset signal PERST and the physical layer initialization signal PHY_INIT are enabled, the reference clock signal selection circuit 140 may enable the reference clock signal detection request REQ_DET. In response to the reference clock signal detection request REQ_DET, the reference clock signal detector 130 may disable a signal DET_VALID indicating that detection of the reference clock signal is valid to a low level, and may enable a signal indicating whether the second reference clock signal REFCLK2 is detected. The detection signal DET_CLK depending on whether the second reference clock signal REFCLK2 is detected may be enabled at a low level.

At T2, the signal DET_VALID indicating that the detection of the reference clock signal is valid may be enabled at a high level.

In an embodiment, the first count value CNT1 corresponding to the first reference clock signal REFCLK1 and the second count value CNT2 corresponding to the second reference clock signal REFCLK2 may be compared against each other. As a result of the comparison, when a difference between the first count value CNT1 and the second count value CNT2 is greater than a threshold value, the comparison result COMP_CLK may have a low level. The NOR gate circuit 146-1 may output a signal at a high level. The signal at the high level may indicate a common clock mode enable signal. As a result, the multiplexer 146-2 may output the second reference clock signal REFCLK2 as the selected reference clock signal SEL_CLK.

FIG. 3B is a diagram illustrating an example in which a separate clock mode is selected based on an embodiment of the disclosed technology.

Referring to FIGS. 2 and 3B, the reset signal PERST may be enabled at TO′.

At T1′, the physical layer initialization signal PHY_INIT may be enabled in response to the reset signal PERST.

When the reset signal PERST and the physical layer initialization signal PHY_INIT are enabled, the reference clock signal selection circuit 140 may enable the reference clock signal detection request REQ_DET. In response to the reference clock signal detection request REQ_DET, the reference clock signal detector 130 may disable the signal DET_VALID indicating that detection the reference clock signal is valid at a low level, and may enable a signal indicating whether the second reference clock signal REFCLK2 is detected. The detection signal DET_CLK corresponding to whether the second reference clock signal REFCLK2 is detected may be enabled at a low level.

At T2′, the signal DET_VALID indicating that detection the reference clock signal is valid may be enabled at a high level.

In an embodiment, the first count value CNT1 corresponding to the first reference clock signal REFCLK1 and the second count value CNT2 corresponding to the second reference clock signal REFCLK2 may be compared against each other. As a result of the comparison, when the difference between the first count value CNT1 and the second count value CNT2 is greater than or equal to a predetermined threshold value, the comparison result COMP_CLK may have a high level. The NOR gate circuit 146-1 may output a signal at a low level. The signal at the low level may indicate the separate clock mode enable signal EN_SRMODE. As a result, the multiplexer 146-2 may output the first reference clock signal REFCLK1 as the selected reference clock signal SEL_CLK.

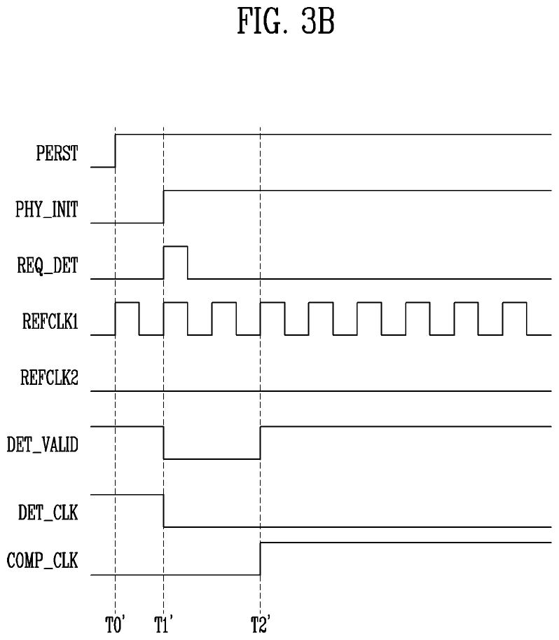

FIG. 4 is a block diagram illustrating the spread spectrum clocking selection circuit 170 based on an embodiment of the disclosed technology.

Referring to FIG. 4, the spread spectrum clocking selection circuit 170 may include a skip ordered set detector 171, a skip ordered set counter 172, a skip ordered set comparator 173, and a mode selector 174.

The skip ordered set detector 171 may detect a skip ordered set SKPOS received through the receiver 110. For example, the skip ordered set detector 171 may receive the data DATA from the receiver 110. The skip ordered set detector 171 may detect the skip ordered set SKPOS included in the data DATA in response to the separate clock mode enable signal EN_SRMODE. The skip ordered set detector 171 may provide the detected skip ordered set SKPOS to the skip ordered set counter 172.

The skip ordered set counter 172 may output a count value CNT_INTERVAL corresponding to a receiving interval in response to the separate clock mode enable signal EN_SRMODE.

In an embodiment, the skip ordered set counter 172 may count the number of times the first reference clock signal REFCLK1 is toggled (e.g., number of toggles between the binary representations of 0 and 1) while the skip ordered set SKPOS is continuously received.

The skip ordered set comparator 173 may compare the receiving interval of the skip ordered set SKPOS with a predetermined interval.

In an embodiment, the skip ordered set comparator 173 may compare a count value CNT_INTERVAL with a reference value CNT_REF corresponding to the predetermined interval.

In an embodiment, the reference value CNT_REF may include a first reference value for determining whether the receiving interval of the skip ordered set SKPOS is the interval corresponding to the first mode. For example, the interval corresponding to the first mode may be set to 261 ns. The first reference value may be 33 when the first reference clock signal REFCLK1 is 125 MHZ. When the count value CNT_INTERVAL is less than 33, the receiving interval of the skip ordered set SKPOS may be the interval corresponding to the first mode. In other words, the first mode may be selected when the current receiving interval of the skip ordered set SKPOS is less than the first reference value, the first mode may be selected. The skip ordered set comparator 173 may output a signal corresponding to the first mode.

In addition, the reference value CNT_REF may include a second reference value for determining whether the receiving interval of the skip ordered set SKPOS is an interval corresponding to the second mode. The second reference value may be greater than the first reference value. For example, the interval corresponding to the second mode may be set to 5 us. The second reference value may be 525 when the first reference clock signal REFCLK1 is 125 MHZ. When the count value CNT_INTERVAL is greater than 525, the receiving interval of the skip ordered set SKPOS may be the interval corresponding to the second mode. In other words, the second mode may be selected when the current receiving interval of the skip ordered set SKPOS is greater than the second reference value. The skip ordered set comparator 173 may output a signal corresponding to the second mode.

The mode selector 174 may select any one of the first mode and the second mode on the basis of a comparison result COMP_SKPOS and a state of the elastic buffer 150. In an embodiment, the mode selector 174 may include an AND gate circuit 174-1.

In an embodiment, the mode selector 174 may receive the comparison result COMP_SKPOS from the skip ordered set comparator 173 and a signal UNDER_FLOW indicating an underflow state from the buffer state detector 160. The mode selector 174 may output the selected mode SEL_MODE to the reference clock signal controller 180 in response to the received signals.

In an embodiment, the mode selector 174 may select the first mode when the mode selector 174 receives the signal corresponding to the first mode and the elastic buffer 150 is in the underflow state.

In an embodiment, the mode selector 174 may select the second mode when the mode selector 174 receives the signal corresponding to the second mode or the elastic buffer 150 is not in the underflow state.

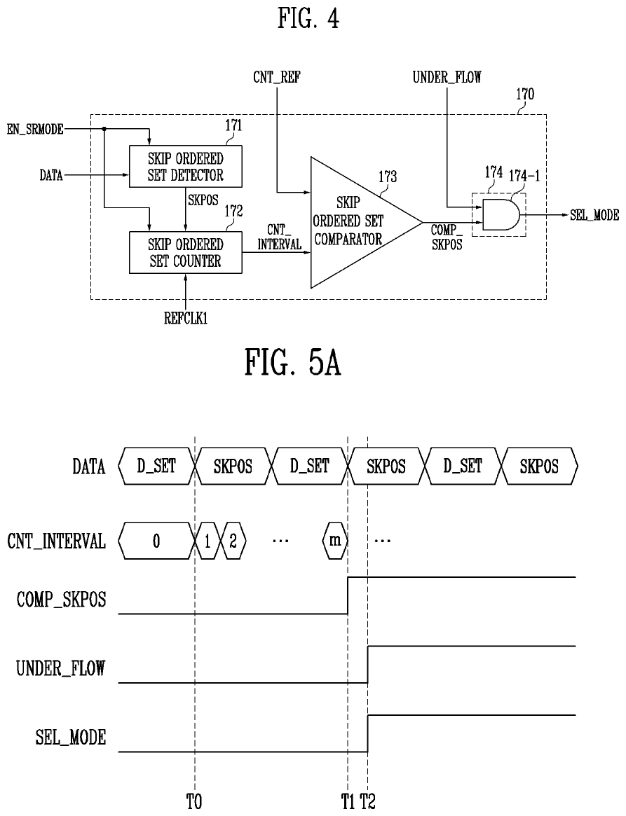

FIG. 5A is a block diagram illustrating an example in which spread spectrum clocking is activated based on an embodiment of the disclosed technology.

Referring to FIGS. 4 and 5A, the data DATA which consists of a data set D_SET and the skip ordered set SKPOS may be input.

The count value CNT_INTERVAL corresponding to the receiving interval of the skip ordered set SKPOS may be calculated during a time period from a time TO at which the skip ordered set is input to a time T1 at which the next skip ordered set is input. The count value CNT_INTERVAL may be output as ‘m’ by the skip ordered set counter 172.

The skip ordered set comparator 173 may output the comparison result COMP_SKPOS at a high level when m is less than a first reference value.

The mode selector 174 may receive the signal UNDER_FLOW indicating the underflow state from the buffer state detector 160. When the signal UNDER_FLOW indicating the underflow state is enabled at the high level, the elastic buffer 150 may be in the underflow state.

Since all input signals have the high level, the mode selector 174 may select the first mode by outputting the selected mode SEL_MODE at the high level.

FIG. 5B is a diagram illustrating an example in which spread spectrum clocking is deactivated based on an embodiment of the disclosed technology.

Referring to FIGS. 4 and 5B, the data DATA which includes the data set D_SET and the skip ordered set SKPOS may be input.

The count value CNT_INTERVAL corresponding to the receiving interval of the skip ordered set SKPOS may be calculated during a time period from the time TO′ at which the skip ordered set is input to the time T1′ at which the next skip ordered set is input. The count value CNT_INTERVAL may be output as ‘n’ by the skip ordered set counter 172.

When n is greater than the second reference value, the skip ordered set comparator 173 may output the comparison result COMP_SKPOS at the low level.

The mode selector 174 may select the second mode by outputting the selected mode SEL_MODE at the low level since the comparison result COMP_SKPOS is at the low level even when the signal UNDER_FLOW indicating the underflow state is at the high level.

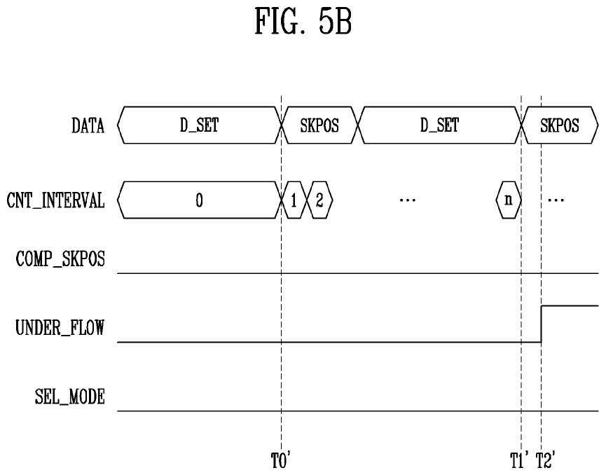

FIG. 6 is a flowchart illustrating a method of operating a PCIe device based on an embodiment of the disclosed technology. The method of FIG. 6 may be performed by, for example, the PCIe device 100 as shown in FIG. 1.

Referring to FIG. 6, at S601, the PCIe device 100 may generate a first reference clock signal.

At S603, the PCIe device 100 may detect a second reference clock signal of the host 200.

At S605, the PCIe device 100 may compare the first reference clock signal with the second reference clock signal.

In an embodiment, the PCIe device 100 may select any one of a common clock mode and a separate clock mode on the basis of a result of comparing the first reference clock signal with the second reference clock signal. For example, the PCIe device 100 may select any one of the common clock mode and the separate clock mode in response to first toggling of a reset signal which is received from the host 200.

At S607, the PCIe device 100 may determine whether the second reference clock signal is provided from the host 200 on the basis of the result of comparing the first reference clock signal with the second reference clock signal.

When it is determined, as a result of determination at S607, that the second reference clock signal is provided from the host 200, the PCIe device 100 may perform step S609. At S609, the PCIe device 100 may select the second reference clock signal according to the common clock mode.

As a result of determination at S607, when it is determined that the second reference clock signal is not provided from the host 200, the PCIe device 100 may perform step S611. At S611, the PCIe device 100 may select the first reference clock signal according to the separate clock mode.

At S613, the PCIe device 100 may determine whether to apply separate spectrum clocking on the first reference clock signal on the basis of the receiving interval of the skip ordered set and the state of the elastic buffer 150.

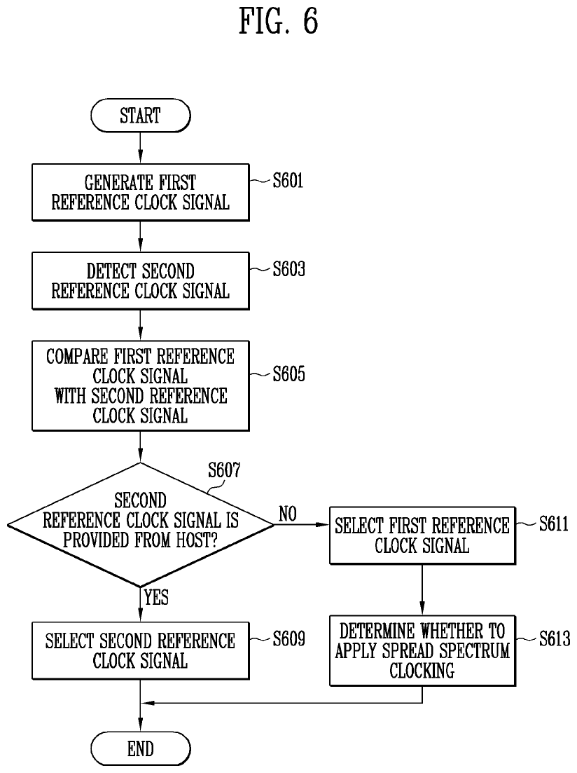

FIG. 7 is a flowchart illustrating an example of a method of operating a PCIe device determining whether to activate spread spectrum clocking based on an embodiment of the disclosed technology. In an embodiment, FIG. 7 may specify step S613 of FIG. 6. The method of FIG. 7 may be performed by, for example, the PCIe device 100 shown in FIG. 1.

Referring to FIG. 7, at S701, the PCIe device 100 may receive a data set and a skip ordered set from the host 200 on the basis of a first reference signal in response to a separate clock mode.

At S703, the PCIe device 100 may store the data set and the skip ordered set in the elastic buffer 150.

At S705, the PCIe device 100 may determine whether the receiving interval of the skip ordered set is shorter than a first interval. For example, the PCIe device 100 may compare the receiving interval and the predetermined first interval. The first interval may correspond to a first reference value.

When, as a result of determination at S705, it is determined that the receiving interval of the skip ordered set is shorter than the first interval, the PCIe device 100 may perform step S707.

At S707, the PCIe device 100 may detect a state of the elastic buffer 150.

At S709, the PCIe device 100 may determine whether the elastic buffer 150 is in an underflow state or not.

When, as a result of determination at S709, it is determined that the elastic buffer 150 is in the underflow state, the PCIe device 100 may perform step S711.

At S711, the PCIe device 100 may activate application of spread spectrum clocking.

On the other hand, when the receiving interval of the skip ordered set is not shorter than the first interval, or when as a result of determination at S709, it is determined that the elastic buffer 150 is not in the underflow state, the PCIe device 100 may perform step S713.

At S713, the PCIe device 100 may deactivate the application of the spread spectrum clocking.

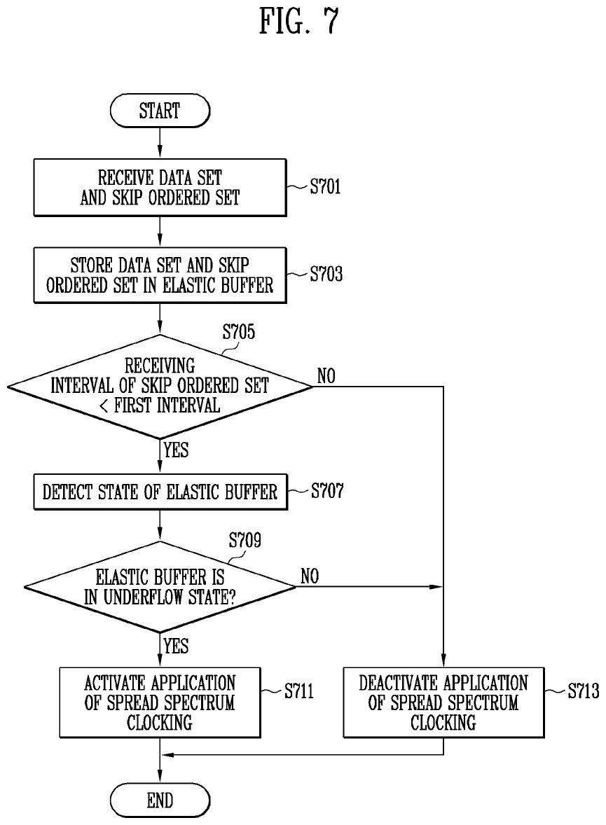

FIG. 8 is a flowchart illustrating another example of a method of operating a PCIe device determining whether to activate spread spectrum clocking based on an embodiment of the disclosed technology. In an embodiment, FIG. 8 may specify step S613 of FIG. 6. The method of FIG. 8 may be performed by, for example, the PCIe device 100 shown in FIG. 1.

Referring to FIG. 8, at S801, the PCIe device 100 may receive a data set and a skip ordered set from the host 200 on the basis of a first reference signal in response to a separate clock mode.

At S803, the PCIe device 100 may store the data set and the skip ordered set in the elastic buffer 150.

At S805, the PCIe device 100 may determine whether the receiving interval of the skip ordered set is longer than a second interval. For example, the PCIe device 100 may compare the receiving interval and the predetermined second interval with each other. The second interval may correspond to a second reference value.

When, as a result of determination at S805, it is determined that the receiving interval of the skip ordered set is longer than the first interval, the PCIe device 100 may perform step S807.

At S807, the PCIe device 100 may deactivate the application of the spread spectrum clocking.

On the other hand, when, as a result of determination at S807, it is determined that the receiving interval of the skip ordered set is not longer than the second interval, the PCIe device 100 may terminate the process.

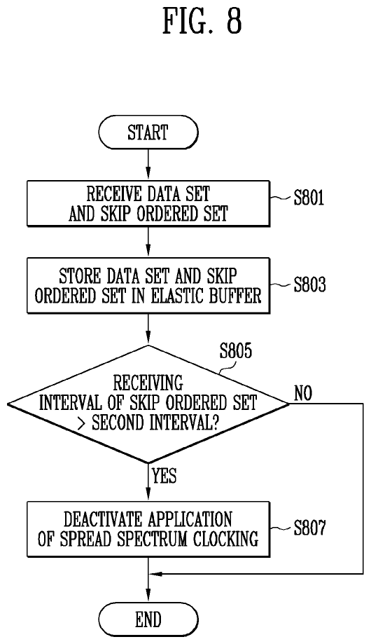

FIG. 9 is a flowchart illustrating an example of activating application of spread spectrum clocking according to a link state based on an embodiment of the disclosed technology.

Referring to FIG. 9, link states of the PCIe device 100, such as a detect state, a polling state, a configuration state, a hot reset state, a disabled state, and an L0 state, are shown in FIG. 9.

The detect state may refer to an initial state after power on or reset. In addition, the link state of the PCIe device may enter this state from states to be described below. For example, the PCIe device may enter the detect state from the configuration state, the hot reset state, the disabled state, an L2 state, a loopback state, and a recovery state. In the detect state, all logics, ports, and registers may be reset, and a link coupled to a PCIe interface may be detected. In other words, in the detect state, a physically coupled lane may be searched for.

In the polling state, a lane which enables data communication may be distinguished from the detected lanes. In the polling state, clocks at both ends of the PCIe interface may be synchronized, it may be confirmed whether the lane has a polarity of D+ or D−, and a data transmission speed available for the lane may be checked. In other words, in the polling state, polarity inversion may be checked. In addition, the link in the polling state may enter the detect state or the configuration state.

In the configuration state, a connection state of the lane may be checked. More specifically, in the configuration state, a lane width which enables data communication may be determined. In addition, in the configuration state, lane reverse may be checked. The PCIe device 100 may enter the configuration state from the polling state. Alternatively, however, after entering the L0 state, the PCIe device 100 may enter the configuration state in the event of “lane reduce” and “lane width up.”

The recovery state may be used to reconfigure a link bandwidth. In the recovery state, a link bandwidth of a set link may be changed, and bit lock, symbol lock and lane-to-lane de-skew may be reset. The recovery state may be entered when an error occurs in the L0 state. Thereafter, after the error is recovered in the recovery state, the state may be changed into the L0 state. In addition, in an embodiment, in the recovery state, an equalization operation of the link may be performed.

The L0 state may be a normal operational state in which data and packets are transmitted and received through the link. More specifically, the L0 state may be an operational state of a physical bus interface in which data and control packets are transmitted and received. The L0 state may be a fully active state.

An Los state may refer to a state in which the physical bus interface quickly enters and recovers from a power conservation state without going through the recovery state. The L0s state may be a power saving state. The L0s state may refer to an idle or standby state of some functions in the interface.

The L1 state may be a power saving state. The L1 state may refer to a state in which a power saving amount is further added as compared to the L0s state. The L1 state may be a low power standby state.

The L2 state may be a power saving state that aggressively conserves power. Most of the transmitters and receivers may be shut off. Although a main power supply and clocks are not guaranteed, an auxiliary power supply may be provided. The L2 state may be a low power sleep state in which power is not supplied to most of the functions.

The loopback state may be used for test and fault isolation. The loopback state may operate only on a lane basis. In the loopback state, a loopback reception lane may be selected and configured.

The disabled state may allow a set link to be disabled until directed.

The hot reset state may only be triggered by a downstream port. The downstream port may use training sequences (e.g., TS1 or TS2) to propagate hot reset. The training sequences TS may be composed of order sets used for initializing bit alignment, symbol alignment and exchange of physical layer parameters. In some embodiments of the disclosed technology, the term “training sequences” may be used to indicate “training sequences ordered sets.”

In an embodiment, the PCIe device 100 may activate application of an SRIS mode or an SRNS mode which is determined by the spread spectrum clocking selection circuit 170 when changing the speed from a Gen1 state in which the PCIe device 100 operates at a rate of 2.5 GT/s to a Gen3 state in which the PCIe device 100 operates at a rate of Aug. 16, 1932 GT/s.

For example, the PCIe device 100 may switch back and forth between the L0 state and the recovery state for speed change. The PCIe device 100 may activate or deactivate the application of the spread spectrum clocking according to the determined mode.

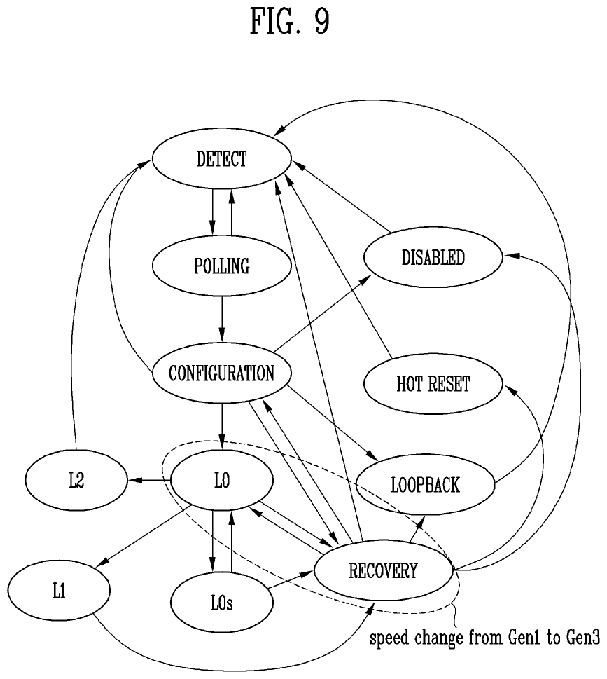

FIG. 10 is a flowchart illustrating another example of activating application of spread spectrum clocking according to a link state based on an embodiment of the disclosed technology. Referring to FIG. 10, the PCIe device 100 may operate in a separate clock mode depending on determination of the reference clock signal selection circuit 140. When the host 200 operates in the SRIS mode and the PCIe device 100 operates in the SRNS which is a default mode, link down may occur.

In an embodiment, the PCIe device 100 may activate the application of the SRIS mode or the SRNS mode determined by the spread spectrum clocking selection circuit 170 when entering the polling state after the link down.

For example, when entering “polling.active” and “polling.configuration” states, the spread spectrum clocking selection circuit 170 may determine that the host 200 operates in the SRIS mode. The PCIe device 100 may activate the application of the spread spectrum clocking according to the determined SRIS mode. The PCIe device 100 may operate properly when trying link up again via the detect state by timeout from “polling.active” and “polling. configuration” states.

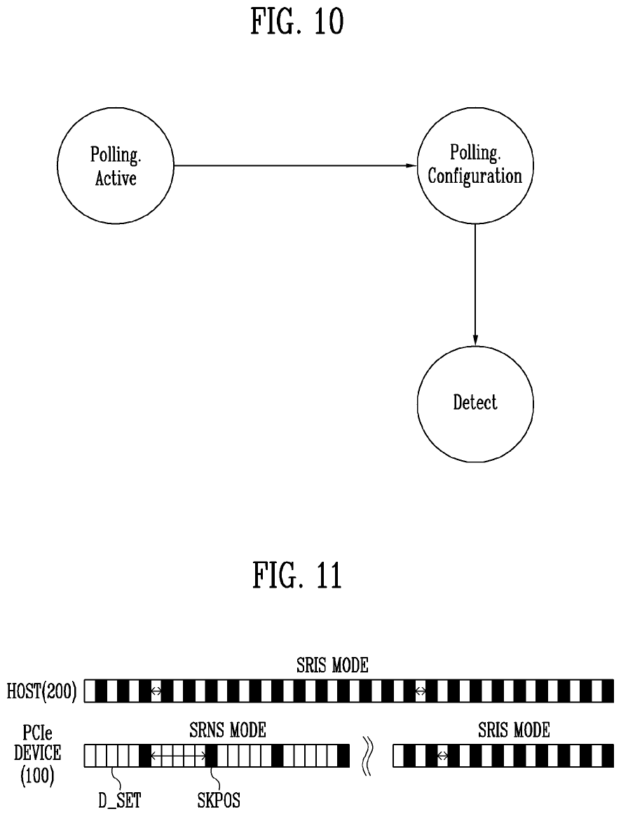

FIG. 11 is a diagram illustrating an example in which spread spectrum clocking is activated based on an embodiment of the disclosed technology.

Referring to FIG. 11, the host 200 may operate in an SRIS mode.

The PCIe device 100 may determine a separate clock mode by the reference clock signal selection circuit 140 and may determine whether to activate spread spectrum clocking through the spread spectrum clocking selection circuit 170. The PCIe device 100 may initially operate in the SRNS mode but may determine that the host 200 operates in the SRIS mode through the spread spectrum clocking selection circuit 170. As a result, at the time described above with reference to FIG. 9 or 10, the PCIe device 100 may operate in the SRIS mode according to the determination of the spread spectrum clocking selection circuit 170.

Therefore, when the PCIe device 100 operates in the separate clock mode, an operation of determining whether to activate the spread spectrum clocking of the PCIe device 100 may be detected by checking whether the interval of the skip ordered set SKPOS is changed at the time corresponding to the link state as described above with reference to FIG. 9 or 10 after power up. The interval of the skip ordered set SKPOS may be detected by various types of protocol analyzers (PA).

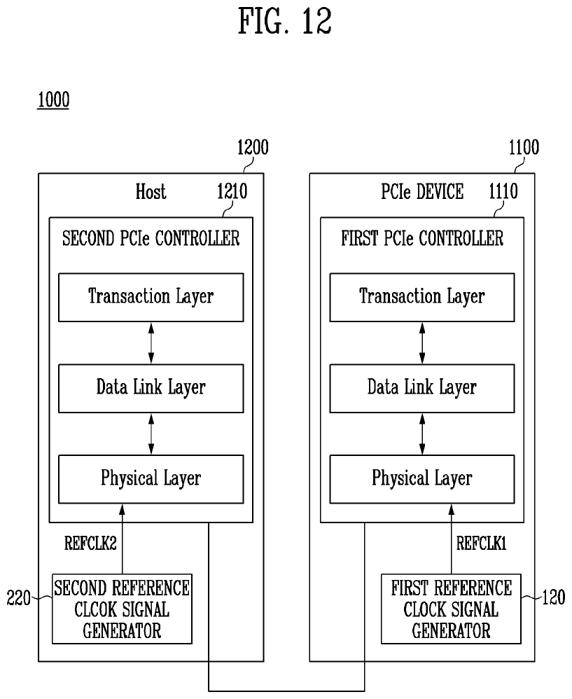

FIG. 12 s a diagram illustrating a PCIe system 1000 based on an embodiment of the disclosed technology.

A PCIe device 1100 and a host 1200 as shown in FIG. 12 may refer to the PCIe device 100 and the host 200 of FIG. 1, respectively.

Referring to FIG. 12, the PCIe system 1000 may include the PCIe device 1100 and the host 1200.

The PCIe device 1100 and the host 1200 may include a first PCIe controller 1110 and a second PCIe controller 1210, respectively. The first PCIe controller 1110 and the second PCIe controller 1210 may have the same structure. Thus, a description will be made based on the first PCIe controller 1110.

The first PCIe controller 1110 may include a PCIe interface. PCIe layers which are included in the PCIe interface may include three discrete logical layers. For example, the PCIe interface may include a transaction layer, a data link layer, and a physical layer. Each of the layers may include two sections. One section may process outbound information (or information to be transferred), and the other section may process inbound information (or received information). In addition, the first PCIe controller 1110 may use packets for communication information between one PCIe interface and another PCIe interface.

The upper layer of the PCIe interface may be a transaction layer. The transaction layer may assemble or disassemble transaction layer packets TLPs. In addition, the transaction layer may implement a split transaction, i.e., a transaction for transferring other traffic to a link while a target system is collecting data required for a response. For example, the transaction layer may implement a transaction in which a request and a response are temporally separated. In an embodiment, four transaction address spaces may include a configuration address space, a memory address space, an input/output address space, and a message address space. A memory space transaction may include at least one of a read request and a write request for transmitting data from/to a memory-mapped location. In an embodiment, the memory space transaction may use two different address formats, e.g., a short address format such as a 32-bit address and a long address format such as a 64-bit address. A configuration space transaction may be used to access a configuration space of the PCIe device 1100. A transaction toward the configuration space may include a read request and a write request. A message space transaction (or a message) may be defined to support in-band communication between PCIe devices.

The transaction layer may store link configuration information or the like. Further, the transaction layer may generate a transaction layer packet (TLP), or may convert a TLP, received from an external device, into a payload or status information.

A middle layer in the PCIe interface structure may be a data link layer, which may function as an intermediate stage between the transaction layer and the physical layer. The data link layer may primarily perform a link management function and a data integrity function including error detection and error correction. Specifically, a transmitting side of the data link layer may accept TLPs assembled by the transaction layer, assign a data protection code to the TLPs, and calculate a TLP sequence number of the TLPs. In addition, the transmitting side of the data link layer may transmit the data protection code and the TLP sequence number to the physical layer so as to transmit the corresponding information through a link. A receiving side of the data link layer may check the data integrity of the TLPs received from the physical layer and transmit the TLPs to the transaction layer for additional processing.

The physical layer may include circuitry for performing interface operations, such as a driver, an input buffer, a serial-to-parallel conversion circuit, a parallel-to-serial conversion circuit, phase-locked loops (PLLs), and an impedance matching circuit.

Further, the physical layer may include a logical sub-block and an electrical sub-block for physically transmitting a packet to an external PCIe device (e.g., a host 1210). The logical sub-block may take a necessary role to perform a ‘digital’ function of the physical layer. In this regard, the logical sub-block may include a transmission section for preparing information to be transmitted by the physical sub-block and a reception section for identifying and preparing received information before transferring the received information to the data link layer. The physical layer may include a transmitter and a receiver. The transmitter may receive symbols serialized by the transmitter by the logical sub-block and sent to an external device. In addition, the receiver may receive the serialized symbols from the external device and convert the received symbols into a bitstream. The receiver may refer to the receiver 110 of FIG. 1. The bitstream may be deserialized and supplied to the logical sub-block. That is, the physical layer may convert TLPs received from the data link layer into a serialized format, and may convert packets received from the external device into a deserialized format. Furthermore, the physical layer may include logical functions related to interface initialization and maintenance.

In an embodiment, the receiver 110, the reference clock signal detector 130, the reference clock selection circuit 140, the elastic buffer 150, the buffer state detector 160, the spread spectrum clocking selection circuit 170, and the reference clock signal controller 180 as shown in FIG. 1 may be included in the physical layer of the PCIe device 1100 shown in FIG. 12. In FIG. 12, the first reference clock signal generator 120 is shown as being included outside the physical layer of the PCIe device 1100. However, in an embodiment, the first reference clock signal generator 120 may be included in the physical layer of the PCIe device 1100.

In an embodiment, the transmitter 210 shown in FIG. 1 may be included in the physical layer of the host 1200 shown in FIG. 12. In FIG. 12, the second reference clock signal generator 220 is shown as being included outside the physical layer of the host 1200. However, in an embodiment, the second reference clock signal generator 220 may be included in the physical layer of the host 1200.

According to another embodiment, the reference clock signal selection circuit 140 and the spread spectrum clocking selection circuit 170 shown in FIG. 1 may be included outside the physical layer of the PCIe device 1100 shown in FIG. 12. The physical layer of the PCIe device 1110 may include the receiver 110, the reference clock signal detector 130, the elastic buffer 150, the buffer state detector 160, and the reference clock signal controller 180.

In FIG. 12, the structures of the first PCIe controller 1110 and the second PCIe controller 1210 are exemplified. However, the first PCIe controller 1110 and the second PCIe controller 1210 may include an arbitrary structure such as a quick path interconnect structure, a next generation high performance computing interconnection structure, or another hierarchical structure.

In this way, the interface device such as the PCIe device based on some embodiments of the disclosed technology can smoothly perform an operation of automatically selecting a clock mode between a common clock mode or a separate clock mode when a plurality of reset signals are enabled, whether to apply spread spectrum clocking can be automatically determined, and a method of operating the PCIe device may be provided.

The disclosure in U.S. patent application Ser. No. 17/081,595, filed on Oct. 27, 2020, is incorporated herein by reference in its entirety.

In an embodiment, a device may provide an interface device capable of adaptively determining a transmission parameter according to a link characteristic of U.S. patent application Ser. No. 17/081,595, which is incorporated herein by reference in its entirety.

The disclosure in U.S. patent application Ser. No. 17/350,945, filed on Jun. 17, 2021, is incorporated herein by reference in its entirety.

In an embodiment, a device may provide a peripheral component interconnect express (PCIe) device that can control a lane margining operation in an upstream port, and a computing system including the PCIe device of U.S. patent application Ser. No. 17/350,945, which is incorporated herein by reference in its entirety.

The disclosure in U.S. patent application Ser. No. 17/350,885, filed on Jun. 17, 2021, is incorporated herein by reference in its entirety.

In an embodiment, a device may provide an improved peripheral component interconnect express (PCIe) interface and an interface system including the same of U.S. patent application Ser. No. 17/350,885, which is incorporated herein by reference in its entirety.

The embodiments and implementations disclosed above are examples only, and thus various enhancements and variations to the disclosed embodiments and implementations and other embodiments and implementations can be made based on what is described and illustrated in this patent document.

What is claimed is:

1. A device in communication with a host device via an interface, comprising:
a clock signal generator configured to generate a first reference clock signal to be used by the device; and
a reference clock signal selection circuit coupled to be in communication with the clock signal generator to receive the first reference clock signal and configured to receive a second reference clock signal from the host device, and configured to, in response to a first reset signal received first among a plurality of reset signals from the host device, select one of the first reference clock signal and the second reference clock signal according to whether the second reference clock signal is provided from the host device.

2. The device of claim 1, wherein the first reset signal is a reset signal that is received first from the host device after a reference clock signal is selected before the one of the first and second reference clock signals is selected by the reference clock signal selection circuit.

3. The device of claim 2, wherein the reference clock signal selection circuit includes a selection circuit controller configured to generate a control signal to select the one of the first and second reference clock signals in response to the first reset signal and a physical layer initialization signal.

4. The device of claim 3, wherein the physical layer initialization signal is enabled until the one of the first and second reference clock signals is selected and initial register values of a physical layer are set.

5. The device of claim 4, wherein the selection circuit controller is configured to: upon receiving a different reset signal other than the first reset signal, block an operation caused by the different reset signal until the one of the first and second reference clock signals is selected and the initial register values of the physical layer is set.

6. The device of claim 3, further comprising a reference clock signal detector configured to detect the second reference clock signal.

7. The device of claim 6, wherein the reference clock signal selection circuit further comprises:
a detection signal generator configured to generate a detection signal upon detecting the second reference clock signal in response to the control signal;
a first counter configured to: determine a number of toggles of the first reference clock signal; and generate a first count value corresponding to the number of toggles of the first reference clock signal in response to the control signal;
a second counter configured to: determine a number of toggles for the second reference clock signal; and generate a second count value corresponding to the number of toggles of the second reference clock signal in response to the control signal;
a reference clock signal comparator configured to compare the first count value with the second count value; and
a reference clock signal selector configured to select the one of the first and second reference clock signals based on the detection signal and a comparison result of the reference clock signal comparator.

8. A device in communication with a host device via an interface, comprising:
a receiver configured to receive a data set and a skip ordered set (SKP OS) from the host device based on a first reference clock signal;
an elastic buffer coupled to the receiver and configured to store the data set and the skip ordered set;
a buffer state detector coupled to the elastic buffer and configured to detect a state of the elastic buffer; and
a spread spectrum clocking selection circuit coupled to the receiver and configured to determine whether to activate spread spectrum clocking (SSC) based on a receiving interval at which the skip ordered set is received and a state of the elastic buffer.

9. The device of claim 8, wherein the spread spectrum clocking selection circuit comprises:
a skip ordered set detector configured to detect the skip ordered set received through the receiver;
a skip ordered set counter configured to: determine a number of toggles of the first reference clock signal while the skip ordered set is received; and generate a count value corresponding to the number of toggles of the first reference clock signal during the receiving interval;
a skip ordered set comparator configured to compare the count value with a predetermined reference value; and
a mode selector configured to select, based on a comparison result of the skip ordered set comparator and a state of the elastic buffer, one of a first mode or a second mode, wherein in the first mode, the spread spectrum clocking is activated, and in the second mode, the spread spectrum clocking is deactivated.

10. The device of claim 9, wherein the skip ordered set comparator is configured to: output a signal corresponding to the first mode upon determination that the count value is less than a first reference value; or output a signal corresponding to the second mode upon determination that the count value is greater than a second reference value that is greater than the first reference value.

11. The device of claim 10, wherein the mode selector receives the signal corresponding to the first mode and selects the first mode in a case that the elastic buffer is in an underflow state.

12. The device of claim 10, wherein the mode selector receives the signal corresponding to the second mode from the skip ordered set comparator, or selects the second mode in a case that the elastic buffers is not in an underflow state.

13. The device of claim 8, further comprising a clock signal generator configured to generate the first reference clock signal.

14. The device of claim 13, wherein the first reference clock signal is different from a second reference clock signal generated by the host device.

15. The device of claim 8, further comprising a reference clock signal generator configured to generate a target reference clock signal having a spread spectrum from the first reference clock signal upon activation of the spread spectrum clocking.

16. A method of operating an interface device in communication with a host device, comprising:
generating a first reference clock signal;
selecting one of a common clock mode and a separate clock mode based on a comparison between the first reference clock signal generated by the interface device and a second clock signal received from the host device;
receiving a data set and a skip ordered set (SKP OS) from the host device based on the first reference clock signal according to the separate clock mode;
storing the data set and the skip ordered set in an elastic buffer; and
determining whether to apply spread spectrum clocking (SSC) to the first reference clock signal based on a receiving interval at which the skip ordered set is received and a state of the elastic buffer.

17. The method of claim 16, wherein the selecting the one of the common clock mode and the separate clock mode is performed in response to an initial toggling of a reset signal received from the host device.

18. The method of claim 16, wherein the determining whether to apply the spread spectrum clocking comprises:
comparing the receiving interval with a predetermined first interval;
detecting the state of the elastic buffer in response to the receiving interval shorter than the predetermined first interval; and
activating application of the spread spectrum clocking in response to detection of an underflow state of the elastic buffer.

19. The method of claim 16, wherein the determining whether to apply the spread spectrum clocking comprises:
comparing the receiving interval with a predetermined second interval; and
deactivating application of the spread spectrum clocking in response to the receiving interval longer than the predetermined second interval.
